(19) United States
(12) Patent Application Publication
(10) Pub. No.: US 2004/0038710 A1
(43) Pub. Date: Feb. 26, 2004

(54) Mobile radiotelephony device with a features that can be released wirelessly by the service provider

(76) Inventor: Oliver Zechlin, Stein (DE)

Correspondence Address: BELL, BOYD & LLOYD, LLC, P. O. BOX 1135, CHICAGO, IL, 60690-1135, US

(21) Appl. No.: 10/381,650

(22) PCT Filed: Sep. 13, 2001
(86) PCT No.: PCT/DE01/03521

(30) Foreign Application Priority Data
Sep. 26, 2000 (DE) 100-47-653.8

(51) Int. Cl. H04M 1/00

(52) U.S. Cl. 455/557

(57) ABSTRACT

A mobile radiotelephony device is provided which allows features to be added on to a low-cost/entry-level device, without having to access the hardware in the device, wherein the features are already contained in the basic equipment of the mobile radiotelephony device but are also blocked to prevent their access, until such time that the functions are released by a user of the mobile radiotelephony device with the aid of a release code that is supplied wirelessly by a service provider in the form of a radio signal.

### BACKGROUND OF THE INVENTION

The present invention relates to a mobile radiotelephony device, in particular a mobile telephone, with an input part and a storage part, in which features of the mobile telephone that can be requested via the input part, such as fax or modem functionality, are implemented and can be requested via the input part, and with a transmitting/receiving component.

Such radiotelephony devices used as a mobile telephones are increasingly supplied with high performance features; in particular, with regard to voice and data services. This wide range of features is deployed principally in mobile telephones in the high price segment. Mobile telephones in the low price segment, on the other hand, are fitted with a smaller range of standard features in order to keep prices low. Software-related features are regularly offered, if these do not compete with the higher price models, with which these features are subject to a charge from customers; in other words, customers pay towards them. Typically these lower price models do not have an integrated software modem, organizer software, pocket calculator functions, etc. If customers require features that are not available in the low price entry-level model, they have to purchase a new, higher price mobile telephone. People buying their first mobile telephone are often not aware of this and it comes as an unpleasant surprise to them some time later, after they have used their standard mobile telephones and gained more experience.

It is, therefore, an object of the present invention to create a mobile telephone as mentioned above, the design of which in the lower cost version easily can be upgraded at any time to a higher price version with more features.

### SUMMARY OF THE INVENTION

The mobile telephone according to the present invention allows features to be added on to a low-cost entry-level device, without having to access the hardware in the device. In this way, for example, voice and data features as well as other software equipment can be extended at low cost and flexibly for the individual intended use. This has the advantage for users that they do not have to replace their radiotelephony device with a more expensive device with features as they did before. Instead users can add the required function on to their existing radiotelephony devices at low cost at any time.

The basis of the present invention is that all possible features, or at least a large number of these, are already contained in the basic equipment in the radiotelephony device but are not all accessible. Instead some of the implemented features are blocked to prevent access via the keypad and can be released wirelessly by a service provider via a special release code. There is then no need to access the hardware in the mobile telephone. Also, the approach according to the present invention saves development costs, as the mobile telephone manufacturers only have to produce a basic device in the nature of a basic platform that it then offers to the respective target group with more or fewer pre-released functions.

The present invention therefore allows extension of the functionality of a radiotelephony device supplied in a basic version by extending the features implemented from the outset in the device that can be released by the user with the aid of a release code that is supplied wirelessly by the service provider in the form of a radio signal.

Advantageously, release is linked to a payment authorization by mobile telephone. The procedure for supplying the release code also advantageously includes a plausibility check. The method according to the present invention for releasing blocked features of a mobile telephone includes the following stages:

The blocked feature is selected from a menu of blocked features and an order is sent to release the selected blocked feature together with a payment authorization to the provider. The release code is sent to the mobile telephone by the provider and the selected blocked feature is released by the received release code. This last feature also may include the release of a number of features at the same time. Also, a plausibility check is preferably carried out by the provider before the release code is sent.

Any input part in the sense of the present invention includes keypads, pen control devices, inclinometers and voice control devices.

Additional features and advantages of the present invention are described in, and will be apparent from, the following Detailed Description of the Invention and the Figures.

### BRIEF DESCRIPTION OF THE FIGURES

FIG. 1 shows the release of blocked features implemented in the mobile radio telephony device in the form of a flowchart.

### DETAILED DESCRIPTION OF THE INVENTION

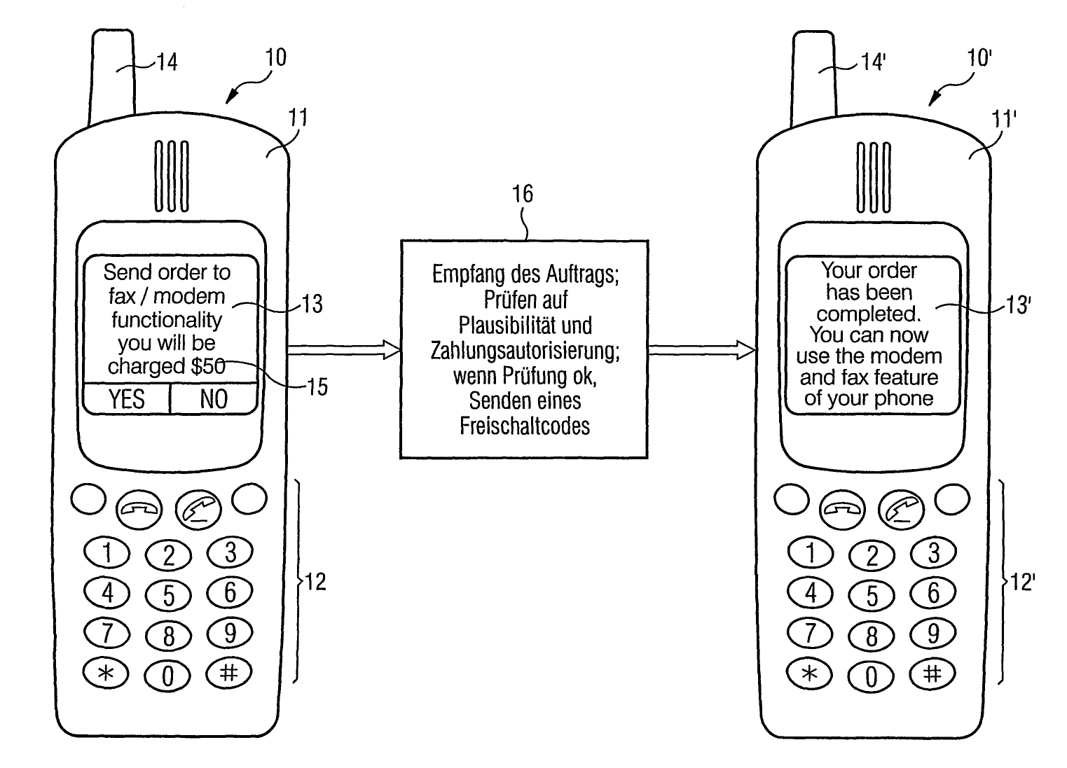

FIG. 1 shows a radiotelephony device configured as a mobile telephone, generally designated with the reference 10 or 10′, in which the two devices shown are the same device that is only shown twice for the selected flow chart diagram. The mobile telephone includes a generally rectangular housing 11, 11′, on the front of which are a keypad 12, 12′ and a screen 13, 13′. The mobile telephone 10 also has a transmitting/receiving antenna 14, 14′ that is part of a transmitting/receiving component that is also contained in the housing 11, as is the remainder of the electronic system of the mobile telephone 10, including a storage part, in which the features of the mobile telephone that can be requested via the keypad, such as fax or module functionality, are implemented and can be requested via this keypad 12, 12′ that represents an example of an input part for this purpose.

According to the present invention, the mobile telephone 10 in the nature of a basic platform, even as a basic device, already contains all the possible features of the mobile telephone, of which however only some are already freely accessible via the keypad 12, 12′ in the basic device. A further number of the features implemented in the mobile telephone 10 are blocked to prevent access via the keypad 12, 12′ and require release via a release code that is supplied wirelessly by a service provider and received by the transmitting/receiving component in the mobile telephone 10 and analyzed in the subsequent electronic system, in order to release the required blocked feature or features.

The release method is shown diagrammatically in FIG. 1 and operates as follows.

A blocked feature is selected from a menu 15 using the keypad 12 of the mobile telephone 10 and shown on the screen 13. In the embodiment shown, the content of the screen reads: “Send order for fax/modem functionality?”; “You will be charged $50”. This text gives the user the option of selecting “yes” or “no”. If the user decides to press the key to select “yes”, this request for feature release is sent via the transmitting/receiving component of the mobile telephone 10 (i.e., via the antenna 14), to a service provider. The service provider carries out a plausibility check in respect of the request and verifies the payment authorization sent at the same time. Once these checks have been completed successfully, the service provider sends a corresponding release code to the mobile telephone 10′. The above-mentioned activity of the service provider is summarized in FIG. 1 in a box 16.

The release code is received via the antenna 14 by the transmitting/receiving component of the mobile telephone 10′ and analyzed in the electronic system of the mobile telephone 10′. The result of the analysis is release of the selected blocked feature or features and confirmation of this process on the screen 13′, on which the following is displayed: “Your order has been completed. You can now use the modem and fax feature of your phone”.

This release process can be repeated for a further feature or features at any time until, where applicable, all the blocked features implemented in the mobile telephone 10 have been released.

Although the present invention has been described with reference to specific embodiments, those of skill in the art will recognize that changes may be made thereto without departing from the spirit and scope of the present invention as set forth in the hereafter appended claims.

Description

Mobile radiotelephony device with features that can be released wirelessly by the service provider.

The present invention relates to a mobile radiotelephony device, in particular a mobile telephone, with an input means and a storage means, in which features of the mobile telephone that can be requested via the input means, such as a fax or modem functionality, are implemented and can be requested via the input means, and with a transmitting/receiving component.

Such radiotelephony devices used as a mobile telephones are increasingly supplied with high performance features, in particular with regard to voice and in the meantime also data services. This wide range of features is deployed principally in mobile telephones in the high price segment. Mobile telephones in the low price segment on the other hand are fitted with a smaller range of standard features, in order to keep prices low. Software-related features are therefore only regularly offered, if these do not compete with the higher price models, with which these features are subject to a charge from customers, in other words customers pay towards them. Typically these lower price models do not have an integrated software modem, organizer software, pocket calculator functions, etc. If customers require features that are not available in the low price entry-level model, they have to purchase a new, higher price mobile telephone. People buying their first mobile telephone are often not aware of this and it comes as an unpleasant surprise to them some time later, after they have used their standard mobile telephones and gained more experience.

It is therefore one of the objects of the present invention to create a mobile telephone as mentioned above, the design of which in the lower cost basic version can easily be upgraded at any time to a higher price version with more features.

This object is achieved by means of the features of claim 1. Advantageous embodiments of the invention are specified in the subclaims.

The mobile telephone according to the invention allows features to be added on to a low-cost entry-level device, without having to access the hardware in the device. In this way for example voice and data features as well as other software equipment can be extended at low cost and flexibly for the individual intended use. This has the advantage for users that they do not have to replace their radiotelephony device with a more expensive device with features as they did before. Instead users can add the required function on to their existing, radiotelephony devices at low cost at any time.

The basis of the invention is that all possible features or at least a large number of these are already contained in the basic equipment in the radiotelephony device but are not all accessible. Instead some of the implemented features are blocked to prevent access via the keypad and can be released wirelessly by a service provider by means of a special release code. There is then no need to access the hardware in the mobile telephone. Also the approach according to the invention saves development costs, as the mobile telephone manufacturers only have to produce a basic device in the nature of a basic platform that it then offers to the respective target group with more or fewer pre-released functions.

The invention therefore allows extension of the functionality of a radiotelephony device supplied in a basic version by extending the features implemented from the outset in the device that can be released by the user with the aid of a release code that is supplied wirelessly by the service provider in the form of a radio signal.

Advantageously release is linked to a payment authorization by mobile telephone. The procedure for supplying the release code also advantageously includes a plausibility check. The method according to the invention for releasing blocked features of a mobile telephone includes the following stages:

The blocked feature is selected from a menu of blocked features and an order is sent to release the selected blocked feature together with a payment authorization to the provider. The release code is sent to the mobile telephone by the provider and the selected blocked feature is released by the received release code. This last feature can also include the release of a number of features at the same time. Also a plausibility check is preferably carried out by the provider before the release code is sent.

Input means in the sense of the invention include keypads, pen control devices, inclinometers and voice control devices.

The invention is described in more detail below using the drawings; the only figure in the drawing shows the release of blocked features implemented in the mobile telephone diagrammatically in the form of a flow chart.

The figure shows a radiotelephony device configured as a mobile telephone, generally designated with the reference 10 or 10′, in which the two devices shown are the same device that is only shown twice for the selected flow chart diagram. The mobile telephone comprises a generally rectangular housing 11, 11′, on the front of which are a keypad 12, 12′ and a screen 13, 13′. The mobile telephone 10 also has a transmitting/receiving antenna 14, 14′ that is part of a transmitting/receiving component that is also contained in the housing 11, as is the remainder of the electronic system of the mobile telephone 10, including a storage means, in which the features of the mobile telephone that can be requested via the keypad, such as a fax or module functionality, are implemented and can be requested via this keypad 12, 12′ that represents an example of an input means for this purpose.

According to the invention the mobile telephone 10 in the nature of a basic platform, even as a basic device, already contains all the possible features of the mobile telephone, of which however only some are already freely accessible via the keypad 12, 12′ in the basic device. A further number of the features implemented in the mobile telephone 10 are blocked to prevent access via the keypad 12, 12′ and require release by means of a release code that is supplied wirelessly by a service provider and received by the transmitting/receiving component in the mobile telephone 10 and analyzed in the subsequent electronic system, in order to release the required blocked feature or features.

The release method is shown diagrammatically in the figure and operates as follows.

A blocked feature is selected from a menu 15 using the keypad 12 of the mobile telephone 10 and shown on the screen 13. In the embodiment shown the content of the screen reads: “Send order for fax/modem functionality?”; “You will be charged $50”. This text gives the user the option of selecting “yes” or “no”. If the user decides to press the key to select “yes”, this request for feature release is sent via the transmitting/receiving component of the mobile telephone 10, i.e. via the antenna 14, to a service provider. The service provider carries out a plausibility check in respect of the request and verifies the payment authorization sent at the same time. Once these checks have been completed successfully, the service provider sends a corresponding release code to the mobile telephone 10′. The above-mentioned activity of the service provider is summarized in the figure in a box 16.

The release code is received via the antenna 14 by the transmitting/receiving component of the mobile telephone 10′ and analyzed in the electronic system of the mobile telephone 10′. The result of the analysis is release of the selected blocked feature or features and confirmation of this process on the screen 13′, on which the following is displayed: “Your order has been completed. You can now use the modem and fax feature of your phone”.

This release process can be repeated for a further feature or features at any time until, where applicable, all the blocked features implemented in the mobile telephone 10 have been released.

1. Radiotelephony device, in particular a mobile telephone, with an input means (12) and a storage means, in which features of the mobile telephone (10) that can be requested via the input means (12), such as a fax or modem functionality, are implemented and can be requested via the input means (12), and with a transmitting/receiving component, characterized in that at least some of the implemented features are blocked to prevent access via the input means (12) and can be released by means of a release code, supplied by a (service) provider (16) in the form of a radio signal that can be received by the transmitting/receiving component.

2. Radiotelephony device according to claim 1, characterized in that a menu is stored in the storage means containing the blocked features, the release of which by the provider (16) can be ordered wirelessly via the transmitting/receiving component using the input means (12).

3. Radiotelephony device according to claim 1 or 2, characterized in that release is linked to a payment authorization by means of the radiotelephony device (10).

4. Radiotelephony device according to one of claims 1 to 3, characterized in that the input means (12) is selected from a group of such devices, including a keypad, a pen control device, an inclinometer and a voice control device.

5. Method for releasing blocked features of a radiotelephony device (10) according to one of claims 1 to 4, characterized by the stages:
The blocked feature is selected from the menu (15) of blocked features, An order is sent to the provider (16) to release the selected blocked feature together with a payment authorization, A release code is sent by the provider (16) to the radiotelephony device (10′),
The selected blocked feature is released by the received release code.

6. Method according to claim 4, characterized in that a plausibility check is carried out before the release code is sent.
